(19) United States
(12) Patent Application Publication
(10) Pub. No.: US 2018/0232312 A1
(43) Pub. Date: Aug. 16, 2018

(54) STORAGE CONTROL DEVICE, METHOD OF STORING DATA, AND STORAGE SYSTEM

(71) Applicant: FUJITSU LIMITED, Kawasaki-shi (JP)

(72) Inventors: Hidekazu KAWANO, Saitama (JP); Hiroaki Konno, Tochigi (JP); Takeshi Ueda, Kawasaki (JP); Hiroshi Koarashi, Takaoka (JP); Hiroshi CHIBA, Chigasaki (JP); Hitomi Akiyama, Kawasaki (JP); Kenji Higuchi, Kawasaki (JP); REISUKE NAKAGAWA, Inagi (JP)

(73) Assignee: FUJITSU LIMITED, Kawasaki-shi (JP)

(21) Appl. No.: 15/885,882

(22) Filed: Feb. 1, 2018

(30) Foreign Application Priority Data
Feb. 16, 2017 (JP) 2017-026521

(51) Int. Cl. G06F 12/0868; G06F 12/0875; G06F 3/06; G06F 12/0831

(52) U.S. Cl. CPC G06F 12/0868; G06F 12/0875; G06F 3/0689; G06F 3/0634; G06F 3/0653; G06F 3/0655; G06F 2212/621; G06F 12/0831; G06F 3/065; G06F 2212/283; G06F 2212/453; G06F 2212/603; G06F 2212/604; G06F 3/0685

(57) ABSTRACT

A control device includes a first and a second control devices, the first control device is configured to transmit second data to the second control device at a first time, receive a first notification from the second control device at a second time, transmit the second data to a storage device at a third time, receive a second notification from the storage device at a fourth time, select a first or a second mode based on a comparison of the first period from the first time to the second time and the second period from the third time to the fourth time, in the first mode, transmit the first data to the second control device and the storage device, receive the first notification, transmit a processing completion notification, in the second mode, transmit the first data to the storage device, receive the second notification, transmit the processing completion notification.

### CROSS-REFERENCE TO RELATED APPLICATION

This application is based upon and claims the benefit of priority of the prior Japanese Patent Application No. 2017-26521, filed on Feb. 16, 2017, the entire contents of which are incorporated herein by reference.

### FIELD

The embodiments discussed herein are related to a storage control device, a method of storing data, and a storage system.

### BACKGROUND

A storage system includes a storage device in which data is recorded and a storage control device that controls the storage device. The storage device is, for example, a non-volatile data storage device such as a solid state drive (SSD) or a hard disk drive (HDD). The storage control device controls the storage device in accordance with a data write request or a data read request that has been received from a host server and writes data to and reads data from the storage device.

For example, when the storage control device has received a data write request (hereinafter referred to as a write command) from the host server, the storage control device executes specific processing related to storage of target data of a write command in the storage device. In addition, the storage control device transmits a processing completion notification to the host server after having completed the specific processing. The host server may execute, for example, processing of generating the next write command or the like after having received the processing completion notification that has been transmitted from the storage control device. Here, the time taken for the host server to receive the processing completion notification from the storage control device after having transmitted the write command to the storage control device is referred to as the response time, When the response time is short, the response speed of the storage control device is high when determined by the host server, and the response speed becomes an index of processing performance of the storage control device. Examples of the related art include Japanese Laid-open Patent Publication No. 08-335144 and Japanese Laid-open Patent Publication No. 10-105467.

### SUMMARY

According to an aspect of the invention, a storage control device configured to store first data transmitted from an information processing device to a storage device, the storage control device includes a first control device including a first memory and a first control device coupled to the first memory, and a second control device including a second memory and a second control device coupled to the second memory, wherein the first control device is configured to at a first time point, transmit second data to the second control device, at a second time point, receive, from the second control device, a first completion notification indicating that the second data is held in the second control device, at a third time point, transmit the second data to the storage device, at a fourth time point, receive, from the storage device, a second completion notification indicating that the second data is stored in the storage device, measure a first time period from the first time point to the second time, point, and a second time period from the third time point to the fourth time point, select one of a first mode and a second mode based on a comparison result of the first time period and the second time period, when the first mode is selected, transmit the first data transmitted from the information processing device to the second control device and the storage device, receive, from the second control device, the first completion notification indicating that the first data is held in the second control device, transmit a processing completion notification to the information processing device when the first completion notification is received, and when the second mode is select, transmit, to the storage device, the first data transmitted from the information processing device, receive, from the storage device, the second completion notification indicating that the first data is stored in the storage device, and transmit the processing completion notification to the information processing device when the second completion notification is received.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a storage system coupled to an information processing device;

FIG. 2 is a diagram illustrating hardware of a control device (CM);

FIG. 3 is a diagram illustrating hardware of a storage device;

FIG. 4 is a ladder chart illustrating processing flow in a write-back mode;

FIG. 5 is a ladder chart illustrating processing ow in a write-through mode;

FIG. 6 is ladder adder chart illustrating processing flow in the write-back mode;

FIG. 7 is a functional block diagram illustrating a processor of the CM;

FIG. 8 is a functional block diagram illustrating a processor of the storage device;

FIGS. 9A and 9B illustrate a measurement method of a first time period and a second time period and a mode selection method based on results of the measurement;

FIG. 10 is diagram illustrating an example of registration contents of a management table;

FIG. 11 is a flowchart illustrating processing of mode selection, which is executed by a processor of a responsible CM;

FIG. 12 is a flowchart illustrating processing of mode selection, which is executed by a processor of a non-responsible CM;

FIG. 13 is a flowchart illustrating processing of mode selection, which is executed by the processor of the storage device;

FIG. 14 is a flowchart illustrating processing when a write command is input after the mode selection, which is executed by the processor of the responsible CM;

FIGS. 15A, 15B and 15C illustrate, a case in which a problem occurs in data ordering when the mode has been switched from the write-back mode to the write-through mode;

FIGS. 16A, 16B, 16C and 16D illustrate a method in which a problem that occurs in the data ordering when the mode has been switched from the write-back mode to the write-through mode is solved;

FIG. 17 is a diagram illustrating a storage system in which each CM functions as a responsible CM for two or more RAID; and

FIG. 18 is a diagram illustrating an example of a registration content of a management table according to a modification.

### DESCRIPTION OF EMBODIMENTS

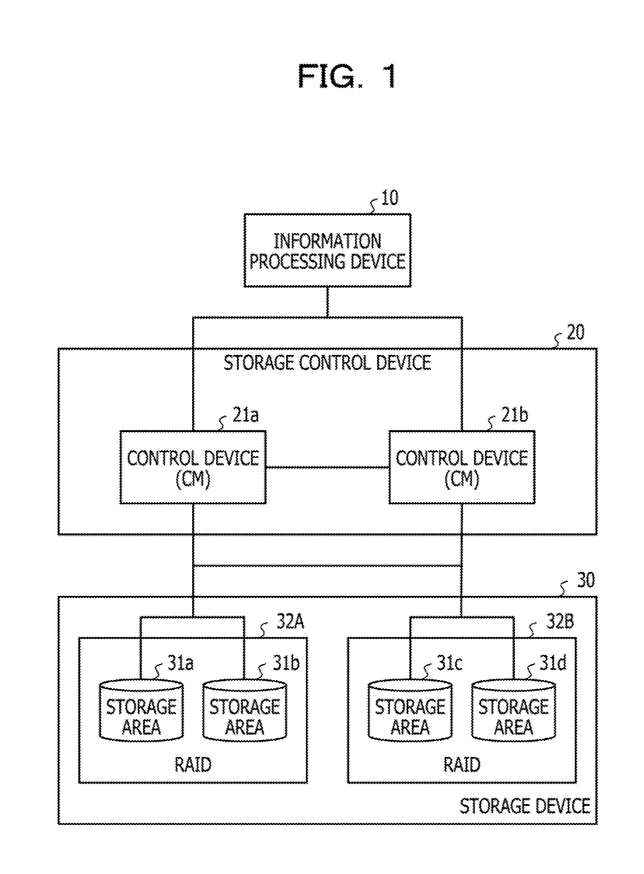

The response time varies depending on a processing load or the like of the storage control device. FIG. 1 is a diagram illustrating a storage system coupled to an information processing device 10. The information processing device 10 is, for example, a host server. The storage system includes a storage control device 20 and a storage device 30. The storage control device 20 includes control devices 21a and 21b. The control devices 21a and 21b are coupled to each other, for example, through a PCI Express (registered trademark) bus and may transmit and receive data to and from each other. The control devices 21a and 21b are referred to as control managers (hereinafter referred to as CMs). Hereinafter, when the CMs 21a and 21b are not distinguished from each other, the CMs 21a and'21b are collectively referred to as a “CM 21” or “CMs 21”.

The storage device 30 includes two or more storage areas 31a, 31b, 31c, and 31d. The two or more storage areas 31a, 31b, 31c, and 31d may be separated storage devices. In FIG. 1, the storage areas 31a and 31b constitute redundant arrays of inexpensive disks (RAID) 32A, and the storage areas 31c and 31d constitute RAID 32B. For example, when the RAID level is RAID1, data is mirrored in the storage areas 31a and 31b. In the embodiment, the RAID level is not limited to the RAID1, and RAID5 may be applied as the RAID level. Hereinafter, when the storage areas 31a, 31b, 31c, and 31d are not distinguished from each other, the storage areas 31a, 31b, 31c, and 31d are collectively referred to as a “storage area 31” or “storage areas 31”. In addition, when the RAID 32A and 32B are not distinguished from each other, the RAID 32A and 32B are collectively referred to as “RAID 32”.

Processing that is executed in the storage control device 20 and the storage device 30 when the information processing device 10 issues a write command to request storage of data in the storage system is described below. The information processing device 10 transmits the write command to one of the CMs 21a and 21b. When the CM21a has received the write command, the CM 1a stores the data in the RAID 32A including the storage areas 31a and 31b. In this case, the CM21a is referred to as a CM responsible for the RAID 32A. Similarly, when the CM 21b has received the write command, the CM 21b writes the data to the RAID 32B including the storage areas 31c and 31d. In this case, the CM 21b is referred to as a CM responsible for the RAID 32B.

When the CM 1a has received the, write command, the CM21a causes a cache memory provided in the CM21a to cache the data. After that, the CM21a executes processing in which the data cached in the cache memory is stored in the RAID 32A. After the data has been stored in the RAID 32A, the data in the cache memory is deleted.

Similarly, when the CM 21b has received the write command, the CM 21b causes a cache memory provided in the CM 21b to cache the data. After that, the CM 21b executes processing in which the data in the cache memory is stored in the RAID 32B. After the data has been stored in the RAID 32B the data in the cache memory is deleted.

In addition, the storage control device 20 includes a function to transmit, to the CM 21b, the data that the CM21a has received from the information processing device 10 and cause the cache memory of the CM 21b to cache the data. Such processing is prepared for a case in which an error occurs in the CM21a and the data in the cache memory of the CM21a is unable to be stored in the RAID 32A. With such processing, when an error has occurred in the CM21a, the data cached in the cache memory of the CM 21b is enabled to be stored in the RAID 32A by the CM21b instead of the CM21a. In this case, the CM21a is referred to as a responsible CM, and the CM 21b is referred to as a non-responsible CM. Similarly, the storage control device 20 includes a function to transmit, to the CM21a, the data that the CM 21b has received from the information processing device 10 and cause the cache memory of the CM21a to cache the data, In this case, the CM 21b is the responsible CM, and the CM 21a is the non-responsible CM. As described above, the CMs 21a and 21b include a function to avoid loss of data by holding identical data each other in a redundant manner.

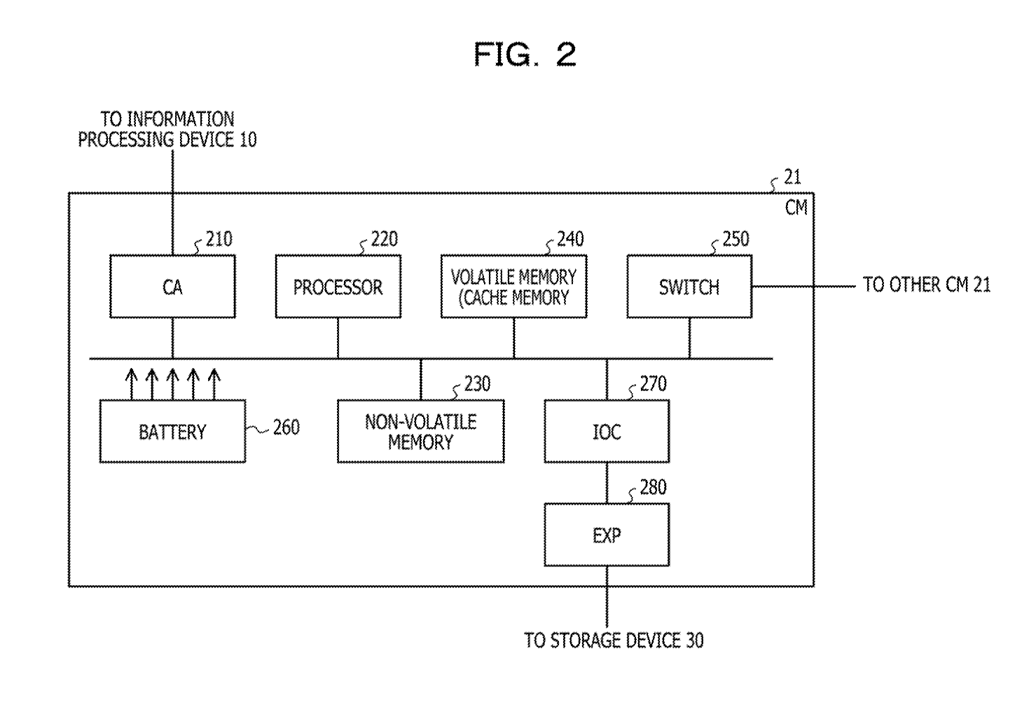

FIG. 2 is a diagram illustrating hardware of the CM 21. The CM 21 includes a channel adaptor (CA) 210, a processor 220, a non-volatile memory 230, a volatile memory 240, a switch 250, a battery 260, an input output controller (IOC) 270, and an expander (EXP) 280. The CA 210 functions as an interface for the information processing device 10 and receives a write command from the information processing device 10. Hereinafter, it is assumed that a write command includes a data write request and target write data. In addition, data that has been read from the storage device 30 is transmitted to the information processing device 10 via the CA 210. In addition, a processing completion notification for the write command that has been received from the information processing device 10 is also transmitted to the information processing device 10 via the CA 210.

The processor 220 loads a computer program stored in the non-volatile memory 230 into the volatile memory 240 and executes the computer program, For example, the processor 220 executes processing of transmitting data to a non-responsible CM or processing of transmitting data to the storage device 30, in response to a received write command. The processor 220 is a hardware processor, and a central processing unit (CPU), a micro controller unit (MCU), a micro processing unit (MPU), a digital signal processor (DSP), a field programmable gate array (FPGA), or the like may be used as the processor 220.

The non-volatile memory 230 is a computer-readable recording medium. The computer program or the like to be executed by the processor 220 is stored in the non-volatile memory 230. The non-volatile memory 230 is, for example, a read only memory (ROM), a mask read only memory (mask ROM), a programmable read only memory (PROM), a flash memory, a magneto-resistive random access memory (MRAM), a resistance random access memory (ReRAM), a ferroelectric random access memory (FeRAM), or the like. The computer program may be stored on a computer-readable recording medium (excluding on carrier waves), which is a storage medium other than the non-volatile memory 230. In addition, a portable recording medium on which the computer program is stored such as a digital versatile disc (DVD) or a compact disc read only memory (CD-ROM) may be distributed. In addition, the computer program may be transmitted over a network.

The volatile memory 240 is a computer-readable recording medium. The computer program stored in the non-volatile memory 230 is loaded into the volatile memory 240. In addition, data used for calculation processing by the processor 220, data obtained as a result of the calculation processing, and the like are stored in the volatile memory 240. In addition, the volatile memory 240 is used as the above-described cache memory, and, for example, when the CM 21 has received a write command, target write data is cached in the cache memory of the CM 21. The volatile memory 240 is, for example, a static random access memory (SRAM), a dynamic random access memory (DRAM), or the like.

The switch 250 functions as an interface for coupling a responsible CM and a non-responsible CM. The switch 250 is, for example, a PCI Express switch. The battery 260 supplies power to the non-volatile memory 230 and the volatile memory 240 such that loss of data stored in the volatile memory 240 is avoided when external power supply to the CM 21 is ceased. The IOC 270 controls transmission and reception of data between the CM 21 and the storage device 30. The EXP 280 relays transmission and reception of data between the CM 21 and the storage device 30.

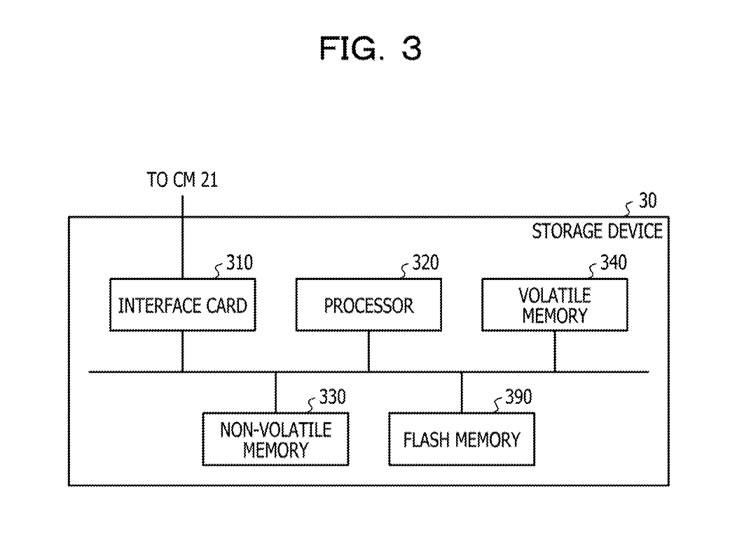

FIG. 3 is a diagram illustrating hardware of the storage device 30. The storage device 30 includes an interface card 310, a processor 320, a non-volatile memory 330, a volatile memory 340, and a flash memory 390. Each of the RAID 32A and 328 illustrated in FIG. 1 is realized by the flash memory 390.

The interface card 310 functions as an interface for the CM 21. The processor 320 executes specific data processing by loading a computer program stored in the non-volatile memory 330 into the volatile memory 340 and executing the computer program. For example, when the storage device 30 receives data from the CM 21, the processor 320 stores the data in the RAID 32 Implemented as the flash memory 390. The processor 320 is a hardware processor, and a CPU, an MCU, an MPU, a DSP, an FPGA, or the like may be used as the processor 320.

The non-volatile memory 330 is a computer-readable recording medium. A computer program or the like to be executed by the processor 320 is stored in the non-volatile memory 330. The non-volatile memory 330 is, for example, a ROM, a mask ROM, a PROM, a flash memory, an MRAM, a ReRAM, a FeRAM, or the like. The volatile memory 340 is a computer-readable recording medium. The computer program stored in the non-volatile memory 330 is loaded into the volatile memory 340. In addition, data used for calculation processing by the processor 320, data obtained as a result of the calculation processing, and the like, are held in the volatile memory 340. The volatile memory 340 is, for example, an SRAM, a DRAM, or the like.

A write-back mode and a write-through mode are described below. Examples of a mode of processing in which the CM 21 that has received a write command from the information processing device 10 stores the data in the storage device 30 include the write-back mode and the write-through mode.

In the write-back mode, processing in which target write data of a write command is transmitted from a responsible CM to a non-responsible CM is executed, and the data is cached in the cache memory of the non-responsible CM. In addition, in the write-back mode, storage processing of storing the data of the responsible CM in the storage device 30 is executed asynchronously with reception of the write command. In addition, in the write-back mode, when the data has been cached in the cache memory of the non-responsible CM, a processing completion notification is transmitted from the responsible CM to the information processing device 10.

In the write-through mode, data is not transmitted from the responsible CM to the non-responsible CM, and data redundancy is not realized between the responsible CM and the non-responsible CM. In addition, in the write-through mode, the data of the responsible CM is stored in the storage device 30 synchronously with reception of a write command. In addition, in the write-through mode, when the data has been stored in the storage device 30, a processing completion notification is transmitted from the responsible CM to the information processing device 10.

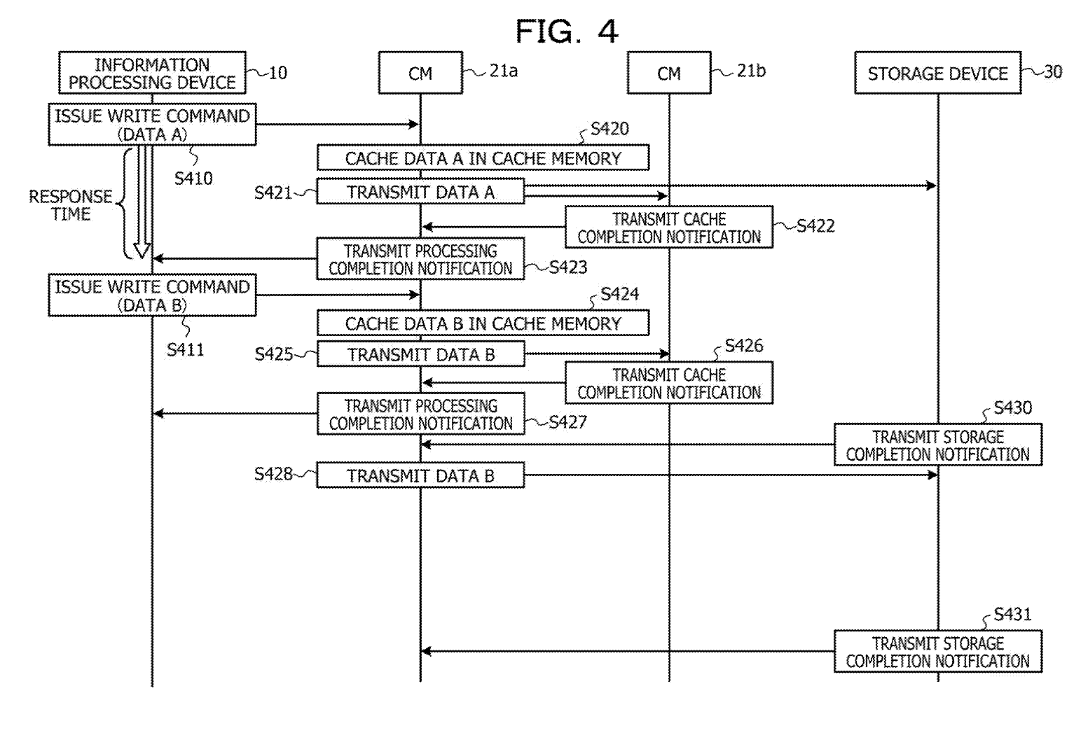

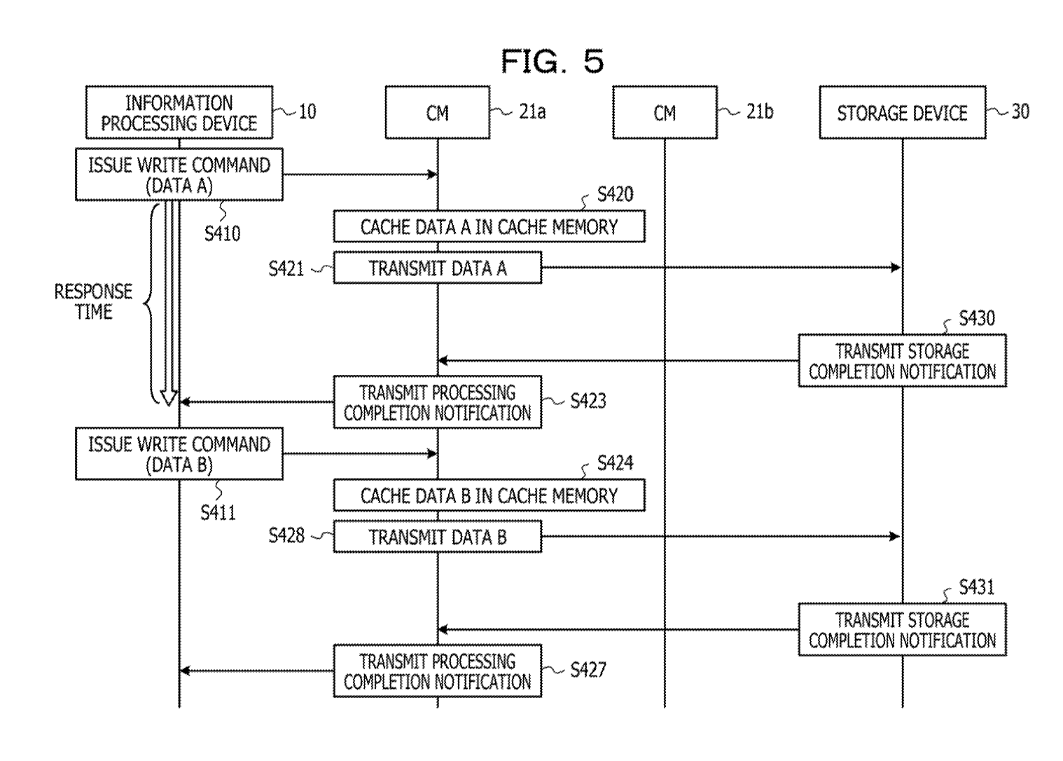

Specific processing in the write-back mode and specific processing in the write-through mode are described below with reference to FIGS. 4 and 5.

### Write-Back Mode

FIG. 4 is a ladder chart illustrating processing flow in the write-back mode. Here, it is assumed that the CM 21a is the responsible CM, and that the CM 21b is the non-responsible CM.

First, in processing S410, the information processing device 10 issues a write command to request that data A be stored in the storage device 30. In processing S420, the CM 21a that is the responsible CM that has received the write command caches the data A in the cache memory of the CM 21a.

Next, in processing S421, the CM 21a executes processing of transmitting the data A to the CM 21b that is the non-responsible CM. In addition, in the processing S421, the CM 21a also executes processing of transmitting the data A to the storage device 30. However, in the processing S421, it is unnecessary that the processing of transmitting the data to the CM 21b and the processing of transmitting the data to the storage device 30 be started at the same time, and the transmission processing may be executed at different times.

After the data A transmitted to the CM 21b has been cached in the cache memory of the CM 21b, the CM 21b transmits, to the CM 21a, a cache completion notification indicating that the data A has been cached in the cache memory of the CM 21b during processing S422. Such a cache completion notification indicates that the CMs 21a and 21b cache identical data in respective cache memories. Therefore, for example, even when an error or the like occurs in the CM 21a in a state in which storage processing of storing the data A in the storage device 30 is not completed, loss of the data A may be avoided. After that, in processing S423, the CM 21a transmits a processing completion notification to the information processing device 10. A time taken for the information processing device 10 to receive the processing completion notification after the information processing device 10 has issued the write command of the data A corresponds to a response time.

The processing completion notification is a notification indicating that the CM 21a has entered a state of waiting to receive the next write command. Therefore, the information processing device 10 may execute, for example, processing or the like in which a write command of data B is issued when the processing completion notification has been received.

As described above, issuance of a processing completion notification from the responsible CM to the information processing device 10 after the data has been transmitted from the responsible CM to the non-responsible CM and has been cached in the cache memory of the non-responsible CM is one of the features of the write-back mode. That is, in the write-back mode, regardless of completion of the storage processing of storing the data in the storage device 30, a response time is determined in accordance with the time taken to implement the data redundancy between the responsible CM and the non-responsible CM.

In addition, processing that occurs when the data is stored in the storage device 30 is described with reference to FIG. 4. Storage processing of storing the data A in the RAID 32A of the storage device 30 is executed after the CM 21a has transmitted the data A to the storage device 30 in the processing S421. After the storage processing of storing the data A in the RAID 32A has been completed, the storage device 30 transmits, to the CM 21a, a storage completion notification indicating that the storage processing of storing the data A in the RAID 32A has been completed in processing S430. In addition, although not illustrated, the data A is deleted from the cache memory of the CM 21a in accordance with the storage completion notification. As a result, a caching area for another data is ensured in the cache memory. In addition, when the data A is deleted from the cache memory of the CM 21a, the CM 21a may instruct the CM 21b to delete the data A in the cache memory of the CM 21b. The CM 21b deletes the data A in the cache memory of the CM 21b in accordance with such an instruction.

Here, a “cache completion notification” is a notification indicating that the non-responsible CM has caused the cache memory of the non-responsible CM to cache data. The “cache completion notification” is transmitted from the non-responsible CM to the responsible CM. In addition, a “storage completion notification” is a notification indicating that the storage device 30 has stored data, and the “storage completion notification” is transmitted from the storage device 30 to the storage control device 20. In addition, a “processing completion notification” is a notification indicating that the specific processing has been completed in response to a received write command, which is transmitted from the storage control device 20 to the information processing device 10.

Typically, the data write speed of writing data to a storage device such as an SSD is slower than the data write speed of writing data to a cache memory that uses the volatile memory 240 such as a DRAM included in the CM 21. Therefore, in FIG. 4, a state is illustrated in which the storage completion notification in the processing S430 is transmitted at a timing later than a timing at which the cache completion notification in the processing S422 is transmitted.

In addition, a processing procedure performed when a write command has been issued before storage processing of storing data of another write command that had been previously issued in the write-back mode in the storage device 30 is completed is described with reference to FIG. 4.

In FIG. 4, after the information processing device 10 has received the processing completion notification that the CM 21a has issued in the processing S423, the information processing device 10 issues a write command of the data B in processing S411. In processing S424, the CM 21a causes the cache memory of the CM 21a to cache the data B, and in processing S425, the CM 21a transmits the data B to the CM 21b. In the example illustrated in FIG. 4, when the CM 21a has transmitted the data B to the CM 21b, storage processing of storing the data A in the storage device 30 has yet to be completed. Therefore, transmission of the data B to the storage device 30 is not executed in the processing S425.

The CM 21b that has received the data B causes the cache memory of the CM 21b to cache the data B and transmits a cache completion notification to the CM 21a in processing S426. In processing S427, the CM 21a transmits a processing completion notification to the information processing device 10. The CM 21a executes processing in which the data B in the cache memory of the CM 21a is transmitted to the storage device 30 (processing S428) after the storage device 30 has transmitted a storage completion notification to the CM 21a (processing S430). That is, until the storage processing of storing the data A is completed, the storage processing of storing the data B is in a standby state, and the data B is cached in the cache memory.

In the processing S428, when the data B has been transmitted to the storage device 30, the storage device 30 executes storage processing of storing the data B in the RAID 32. When the storage processing has been completed, the storage device 30 transmits a storage completion notification to the CM 20a in processing S431. After that, the CM 21a deletes the data B from the cache memory.

As described above, in the write-back mode, regardless of completion of the storage processing of storing data in the storage device 30, a processing completion notification is issued after the data has been cached in the cache memory of the non-responsible CM. Therefore, a response time to the information processing device 10 is determined depending on the time taken to realize data redundancy between the responsible CM and the non-responsible CM. In addition, in the write-back mode, even during the data storage processing of storing data in the storage device 30, the responsible CM may further receive the next write command. In this case, storage processing of storing data in the storage device 30 is executed asynchronously with reception processing of a write command in the responsible CM.

In the write-back mode, the cache memory of the responsible CM may become saturated with two or more write commands and may enter a state (cache miss state) in which a further write command is unable to be received. In this case, processing in which data in the cache memory is stored in the storage device 30 is executed in order, and until free space in the cache memory is ensured by completion of the storage processing, a write command is in a standby state of waiting for input to the storage control device 20. After the free space has been ensured in the cache memory, the write command is received by the responsible CM.

### Write-Through Mode

FIG. 5 is a ladder chart illustrating processing flow in the write-through mode. As described above, in the write-through mode, data is not transmitted from the responsible CM to the non-responsible CM, and storage processing of storing data in the storage device 30 is executed. The write-through mode may be selected, for example, when an error occurs in at least one of the responsible CM and the non-responsible CM or when an error occurs in communication between the responsible CM and the non-responsible CM, and processing in which data is stored in the non-responsible CM is unable to be executed. Here, it is assumed that the CM 21a is the responsible CM and that the CM 21b is the non-responsible CM. The same symbol denotes processing having identical content as the processing described with reference to FIG. 4.

First, in the processing S410, the information processing device 10 issues a write command of data A. In the processing S420, the CM 21a that has received the write command causes the cache memory of the CM 21a to hold the data A. In addition, in the processing S421, the CM 21a transmits the data A to the storage device 30. The storage device 30 executes storage processing of storing the data A that has been transmitted from the CM 21a in the RAID 32. When the storage processing has been completed, in the processing S430, the storage device 30 transmits a storage completion notification to the CM 21a. In the processing S423, the CM 21a transmits a processing completion notification to the information processing device 10 after having received the storage completion notification from the storage device 30.

As described above, in the write-through mode, processing in which data is held between the responsible CM and the non-responsible CM in a redundant manner is not executed, and a processing completion notification is issued after the storage processing of storing the data in the storage device 30 has been completed. That is, the response time is controlled to correspond to a time taken to store the data in the storage device 30.

In FIG. 5, when the information processing device 10 has received the processing completion notification from the CM 21a, the information processing device 10 may further issue a write command. In addition, in the processing S411, the information processing device 10 transmits a write command corresponding to data B to the CM 21a. In the processing S424, the CM 21a causes the cache memory of the CM 21a to cache the data B. In addition, in the processing S428, the CM 21a transmits the data B to the storage device 30. After that, in the processing S431, the storage device 30 transmits a storage completion notification indicating that storage processing of storing the data B in the RAID32 has been completed. In the processing S427, the CM 21a transmits a processing completion notification to the information processing device 10 after having received the storage completion notification from the storage device 30.

A difference between the processing S428 in the write-back mode illustrated in FIG. 4 and the processing S428 in the write-through mode illustrated in FIG. 5 is described below. In FIG. 4, the data B is not transmitted to the storage device 30 after having been cached in the cache memory of the CM 21a in the processing S424 until the storage processing of storing the data A corresponding to the write command that has been previously issued is completed. That is, in the CM 21a, reception of the write command by the CM 21a and transmission of the data B to the storage device 30 are asynchronous.

On the contrary, in FIG. 5, by the time the write command of the data B has been received by the CM 21a, the storage processing of storing the data A in the storage device 30 has already been completed. Therefore, the data B that has been cached in the cache memory of the CM 21a is transmitted to the storage device 30 without waiting for a storage completion notification from the storage device 30. That is, transmission of the data B to the storage device 30 is executed synchronously reception of the write command in the CM 21a.

The difference between the processing contents of the write-back mode and the write-through mode is described above. Here, the two modes are compared for response performance and a processing load of the processor 220 of the CM 21. In the write-back mode, a processing completion notification is issued in accordance with a cache completion notification from the non-responsible CM. Therefore, when a cache completion notification from the non-responsible CM is transmitted earlier than a storage completion notification from the storage device 30, a better response performance may be obtained in the write-back mode. However, the processing load of the processor 220 of the CM 21 in the write-back mode becomes larger than the processing load of the processor 220 of the CM 21 in the write-through mode. This is why, in the write-through mode, transmission and reception processing of data is not executed between the responsible CM and the non-responsible CM, but in the write-back mode, transmission and reception processing of data is executed between the responsible CM and the non-responsible CM.

A case is described below in which a response time in the write-back mode may become longer than a response time in the write-through mode. In FIG. 4, the case is described above in which, in the write-back mode, a cache completion notification from the non-responsible CM is transmitted earlier than a storage completion notification from the storage device 30. However, the cache completion notification from the non-responsible CM may be transmitted later than the storage completion notification from the storage device 30 depending on a state of a processing load of the processor 220 of the responsible CM or the non-responsible CM or the like. For example, when many write commands have been input to the responsible CM in a short time period, or when a processing load of the processor 220 of the non-responsible CM is high, communication speed between the responsible CM and the non-responsible CM is reduced. In addition, a command may wait for being input to the storage control device 20 until storage processing of storing data of a previously-input write command is completed, and the data is deleted from the cache memory after the cache memory of the responsible CM has been saturated. In such a state, a timing of a cache completion notification from the non-responsible CM and a timing of a storage completion notification from the storage device 30 may be reversed.

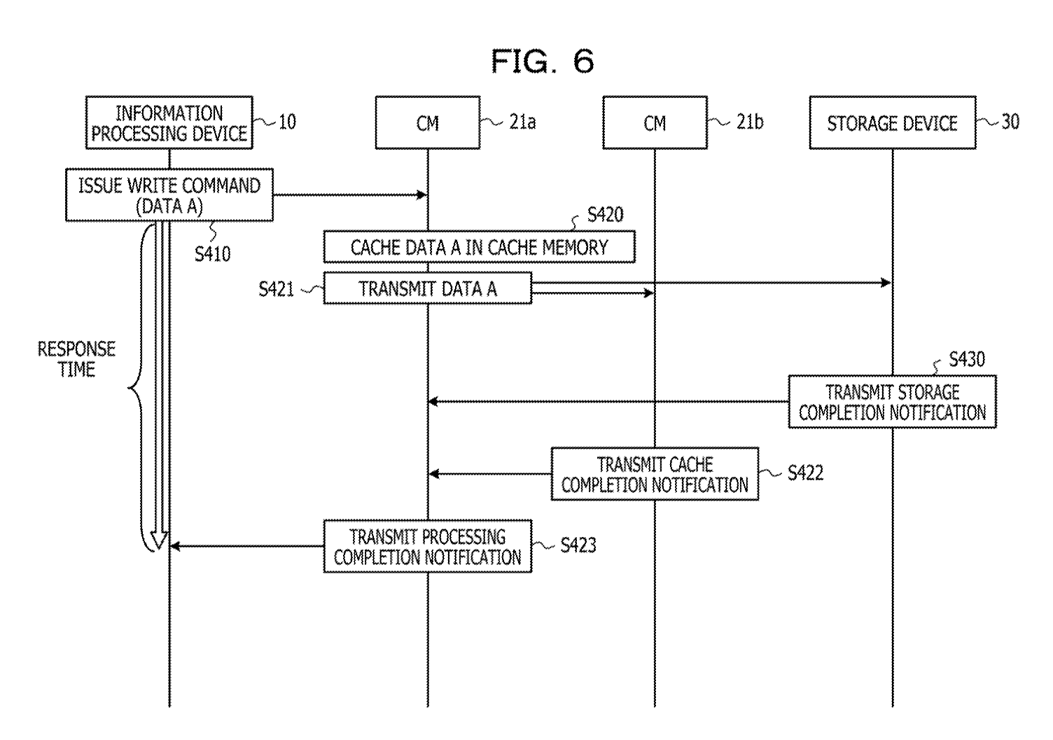

FIG. 6 is a ladder chart illustrating processing flow in the write-back mode. Differently from FIG. 4, the example is described in which a cache completion notification from the non-responsible CM is transmitted later than a storage completion notification from the storage device 30. The same symbol denotes identical processing as the processing illustrated in FIG. 4.

First, in the processing S410, the information processing device 10 issues a write command of the data A to the CM 21a. In the processing S420, the CM 21a that has received the write command caches the data A in the cache memory of the CM 21a. In addition, in the processing S421, the CM 21a transmits the data A to the CM 21b that is the non-responsible CM. In addition, in the processing S421, the CM 21a transmits the data A to the storage device 30.

In the processing S430, the storage device 30 transmits, to the CM 21a, a storage completion notification indicating that the data A has been stored in the RAID 32A. After that, in the processing S422, the CM 21b transmits, to the CM 21a, a cache completion notification indicating that the data A has been cached in the cache memory of the CM 21b. In addition, in the processing S423, the CM 21a transmits a processing completion notification to the information processing device 10 in accordance with the cache completion notification.

As described above, in the example illustrated in FIG. 6, a time taken to realize data redundancy between the responsible CM and the non-responsible CM becomes longer than a time taken to store the data in the storage device 30. Therefore, when a processing completion notification is issued in the write-back mode, a response time to the information processing device 10 becomes longer than a case in which a processing completion notification is issued in the write-through mode. In such a case, it is desirable that the write-through mode is selected in a response performance viewpoint. In addition, when the processing in the write-back mode is executed, processing loads of the processors 220 of the responsible CM and the non-responsible CM increase compared with the write-through mode.

In accordance with such a consideration, in the embodiment, from among the write-back mode and the write-through mode, a mode is selected in which a response time to the information processing device 10 is short. That is, when a shorter response time is expected in the write-back mode, the write-back mode is selected. On the contrary, when a shorter response time is expected in the write-through mode, the write-through mode is selected.

In the embodiment, specific data, for example, sample data is transmitted from the responsible CM to the non-responsible CM and the storage device 30. In addition, a first time period until the responsible CM receives a cache completion notification from the non-responsible CM is compared with a second time period until the responsible CM receives a storage completion notification from the storage device 30. When the first time period is shorter than the second time period, the write-back mode is selected, and when the first time period is longer than the second time period the write-through mode is selected.

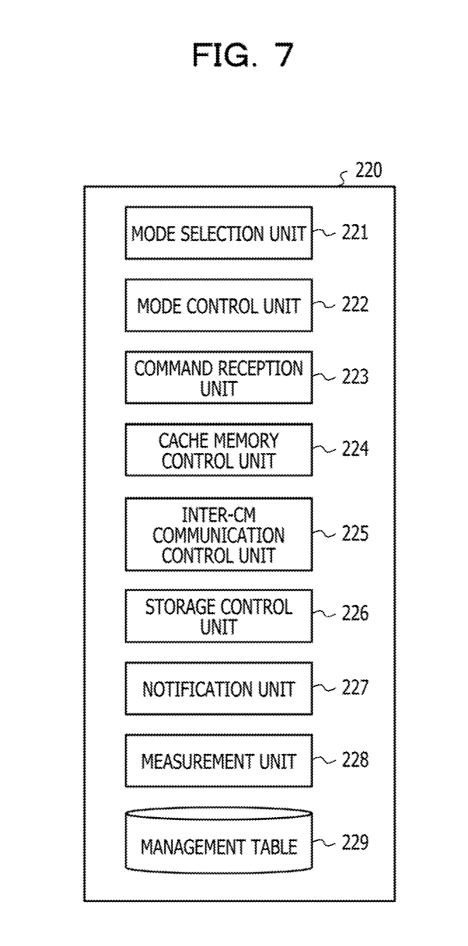

FIG. 7 is a functional block diagram illustrating the processor 220 of the CM 21. The functional block illustrated in FIG. 7 may be applied to any one of the CM 21a and the CM 21b.

The processor 220 functions as a mode selection unit 221, a mode control unit 222, a command reception unit 223, a cache memory control unit 224, an inter-CM communication control unit 225, a storage control unit 226, a notification unit 227, a measurement unit 228, and a management table 229 by executing a computer program. The management table 229 may not be realized by the processor 220, and may be realized, for example, by the volatile memory 240.

The mode selection unit 221 selects the write-back mode or the write-through mode in accordance with measurement results of the measurement unit 228, which are described later, and stores the selected mode. The mode control unit 222 performs control corresponding to the mode selected and stored by the mode selection unit 221. The command reception unit 223 receives a command, for example, a write command from the information processing device 10. For example, the cache memory control unit 224 controls the cache memory installed in the volatile memory 240 of the CM 21. For example, when the write command has been received by the command reception unit 223, the cache memory is caused to cache target data of a write command. The inter-CM communication control unit 225 controls communication between the responsible CM and the non-responsible CM. For example, when the responsible CM has received the write command, the inter-CM communication control unit 225 controls communication between the responsible CM and the non-responsible CM and transmits target data of the write command to the non-responsible CM. In addition, the inter-CM communication control unit 225 receives a cache completion notification from the non-responsible CM. That is, the inter-CM communication control unit 225 functions as a transmission and reception unit in communication between the responsible CM and the non-responsible CM. The storage control unit 226 transmits the data to the storage device 30 and causes the storage device 30 to store the data. In addition, the storage control unit 226 receives a storage completion notification from the storage device 30. That is, the storage control unit 226 functions as a transmission and reception unit in communication between the CM 21 and the storage device 30. When the write command has been received from the information processing device 10, and specific processing has been completed, the notification unit 227 transmits a processing completion notification to the information processing device 10. The specific processing corresponds to reception of a cache completion notification from the non-responsible CM when the write-back mode has been selected and corresponds to reception of a storage completion notification from the storage device 30 when the write-through mode has been selected. The measurement unit 228 measures a first time period until a cache completion notification is received from the non-responsible CM after the sample data has been transmitted to the non-responsible CM. In addition, the measurement unit 228 measures a second time period until a storage completion notification is received from the storage device 30 after the sample data has been transmitted to the storage device 30. In addition, the measurement unit 228 registers the measured first time period and second time period in the management table 229. The management table 229 holds the first time period and the second time period that have been measured by the measurement unit 228. The above-described mode selection unit 221 selects a mode with reference to the registration contents of the management table 229.

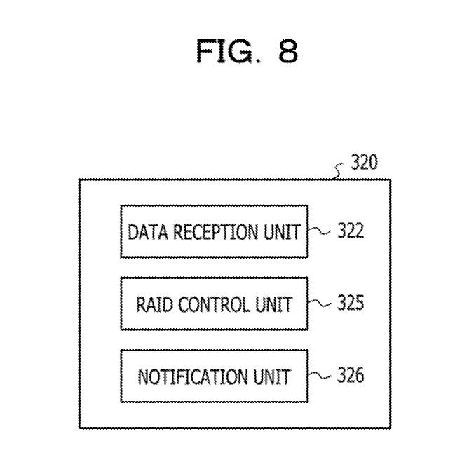

FIG. 8 is a functional block diagram of the processor 320 of the storage device 30. The processor 320 functions as a data reception unit 322, RAID control unit 325, and a notification unit 326 by executing a computer program.

The data reception unit 322 receives data from the storage control device 20. The RAID control unit 325 executes processing in which data is stored in the RAID 32. The notification unit 326 transmits, to the storage control device 20, a storage completion notification indicating that data has been stored in the RAID 32.

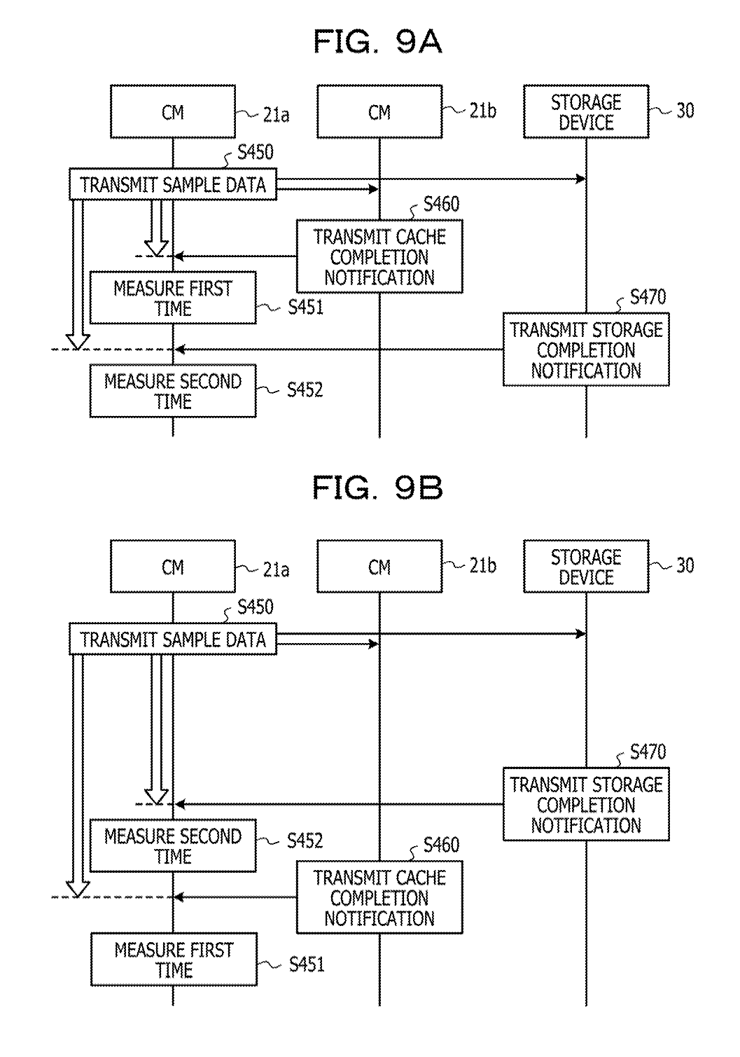

FIGS. 9A and 9B illustrate a measurement method of a first time period and a second time period and a mode selection method based on results of the measurement. FIG. 9A is a diagram illustrating a case in which the write-back mode has been selected, The CM 21a makes sample data. The sample data is, for example, data of 64KBytes, which is used to measure the first time period and the second time period. In addition, the CM 21b ensures a memory area used to cache the sample data in the cache memory, separately from the memory area in which another data (for example, target data of a write command) is held.

In processing S450, the CM 21a transmits the sample data to the

CM 21b. The sample data is held in a sample data area. After that, in processing S460, the CM 21b transmits a cache completion notification to the CM 21a.

In addition, the storage device 30 ensures a memory area used to hold the sample data in the RAID 32, separately from a memory area in which another data is held. In addition, in the processing S450, the CM 21a transmits the sample data to the storage device 30. In processing S470, the storage device 30 transmits a storage completion notification after having stored the sample data in the sample data area.

In processing S451, the CM 21a measures a time (first time period) until a cache completion notification is received after the sample data has been transmitted to the CM 21b. In addition, in processing S452, the CM 21a measures a time (second time period) until a storage completion notification is received after the sample data has been transmitted to the storage device 30. In the example illustrated in FIG. 9A, the first time period is shorter than the second time period. In this case, a shorter response time is expected when the write-back mode is selected. Therefore, the mode selection unit 221 selects the write-back mode, and a write command accepted after the selection is processed in the write-back mode.

FIG. 9B is a diagram illustrating a case in which the write-through mode has been selected. Processing contents executed by the CM 21a, the CM 21b, and the storage device 30 are identical to the contents described with reference to FIG. 9A. However, the example illustrated in FIG. 9B is different from the example illustrated in FIG. 9A in that the measured first time period is longer than the second time period.

As described above, in a case in which a time taken to realize data redundancy between the CM 21a and the CM 21b is long, for example, when processing loads of the processors 220 of the CMs 21a and-21b are high, the first time period may be longer than the second time period. In such a case, a shorter response time may be expected when the write-through mode is selected. Therefore, the mode selection unit 221 selects the write-through mode, and write commands accepted after the selection are processed in the write-through mode. When the write-through mode has been selected, data is not transmitted and received between the CM 21a and the CM 21b, and therefore, processing loads of the processors 220 of the CMs 21a and 21b may be reduced.

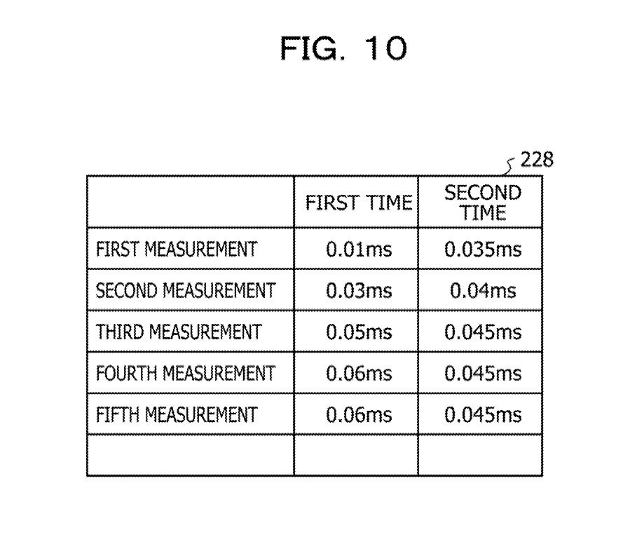

FIG. 10 is a diagram illustrating an example of registration contents of the management table 229. The first time period and the second time period that have been measured by the measurement unit 228 are registered in the management table 229. Each of the first time period and the second time period is measured multiple times. For example, the CM 21a repeatedly transmits sample data and measures the first time period and the second time period, at specific time intervals, for example, at 30-seconds intervals. The first time period and the second time period vary with the passage of time depending on processing loads of the processors 220 of the CMs 21a and 21b.

Here, “30 seconds” is described above as an example of a measurement interval for the first time period and the second time period, but the measurement may be performed at shorter time intervals. When a time interval of the measurement is short, and the first time period or the second time period is longer than the time interval of the measurement, identification information is applied to sample data. Due to the identification information applied to the sample data, a relationship between the sample data that has been transmitted from the responsible CM and a cache completion notification and a storage completion notification that have been received by the responsible CM may be recognized.

In the example illustrated in FIG, 10, in the first and the second measurement, the first time period is shorter than the second time period, such that the mode selection unit 221 selects the write-back mode. However, in the third measurement, the first time period is longer than the second time period, such that the mode selection unit 221 selects the write-through mode. After that, even in the fourth and the fifth measurement, the first time period tends to be longer than the second time period, such that the write-through mode is maintained.

Another example of the mode selection method based on the management table 229 is described below. In the example illustrated in FIG. 10, in the third measurement result, the first time period is longer than the second time period. However, if the write-back mode and the write-through mode are switched in accordance with only one measurement result, frequent switching of a mode may occur. In order to suppress frequent switching of a mode, a mode selected may be determined in accordance with two or more measurement results. For example, when a magnitude relation between the first time period and the second time period becomes identical in two consecutive measurements, the mode may be switched. In the example of FIG. 10, the first time period is longer than the second time period in the third measurement, but switching from the write-back mode to the write-through mode is not executed at such a time point. In addition, switching from the write-back mode to the write-through mode is performed when the first time period is longer than the second time period in the fourth measurement (the first time period is longer than the second time period in two consecutive times). Alternatively, as a further example, a mode may be selected, for example, in accordance with a trend of an average of the recent five consecutive measurement results. Even in this case, frequent switching of a mode may be suppressed.

The measurement of the first time period and the second time period and registration of the measurement results in the management table 229 are performed by each of the Chis 21a and 21b. This is why there is a case in which the CM 21b becomes a responsible CM and receives a write command.

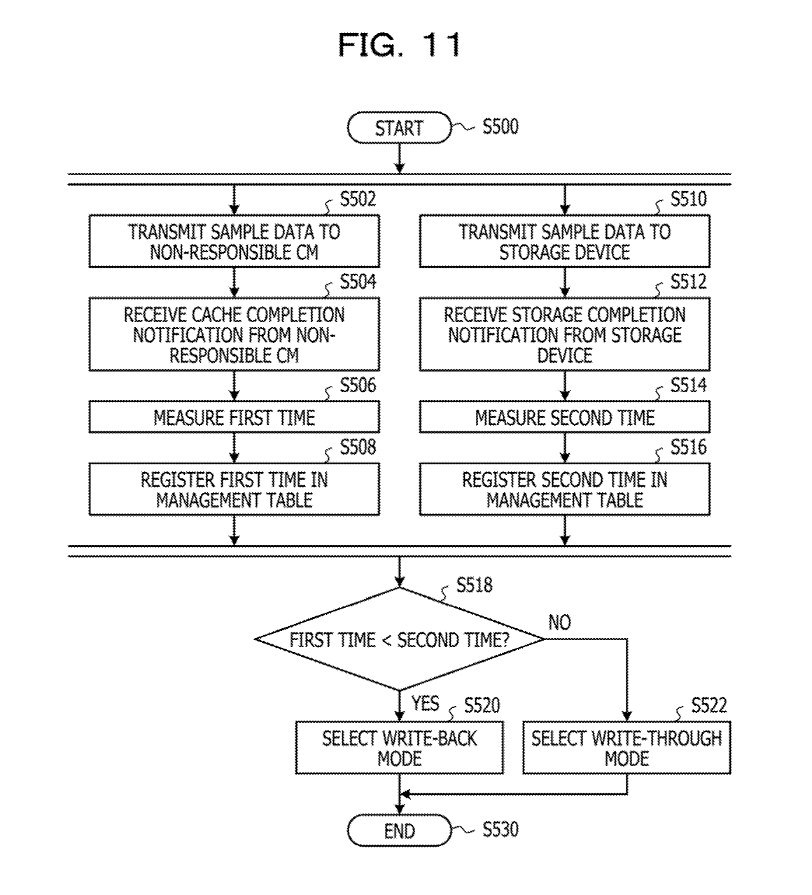

FIG. 11 is a flowchart illustrating processing of mode selection, which is executed by the processor 220 of the responsible CM. The processing flow is started in processing S500, and the inter-CM communication control unit 225 transmits sample data to the non-responsible CM in processing S502. After that, in processing S504, the inter-CM communication control unit 225 receives a cache completion notification from the non-responsible CM. In processing S506, the measurement unit 228 measures a first time period until the cache completion notification is received after the sample data has been transmitted. In addition, in processing S508, the measurement unit 228 registers the measured first time period in the management table 229.

In addition, in processing S510, the storage control unit 226 transmits the sample data to the storage device 30. After that, in processing S512, the storage control unit 226 receives a storage completion notification from the storage device 30. In processing S514, the measurement unit 228 measures a second time period until the storage completion notification is received after the sample data has been transmitted. In addition, in processing S516, the measurement unit 228 registers the measured second time period in the management table 229.

After the first time period and the second time period have been registered in the management table 229, the mode selection unit 221 determines whether the first time period is shorter than the second time period with reference to the management table 229 in processing S518. When the mode selection unit 221 determines that the first time period is shorter than the second time period, the processing flow proceeds to processing S520, and when the mode selection unit 221 determines that the first time period is not shorter than the second time period, the processing flow proceeds to the processing S522. In the processing S520, the mode selection unit 221 selects the write-back mode and in processing S522, the mode selection unit 221 selects the write-through mode. After that, the processing flow ends in processing S530.

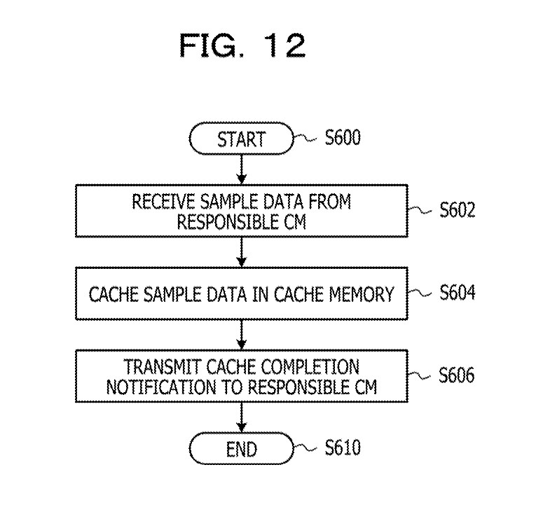

FIG. 12 is a flowchart illustrating processing of mode selection, which is executed by the processor 220 of the non-responsible CM. The processing flow is started in processing S600, and in processing S602, the inter-CM communication control unit 225 receives sample data from the responsible CM. In addition, in processing S604, the cache memory control unit 224 causes the cache memory to cache the sample data. In addition, in processing S606, the inter-CM communication control unit 225 transmits a cache completion notification to the responsible CM, and in the processing S610, the processing flow ends.

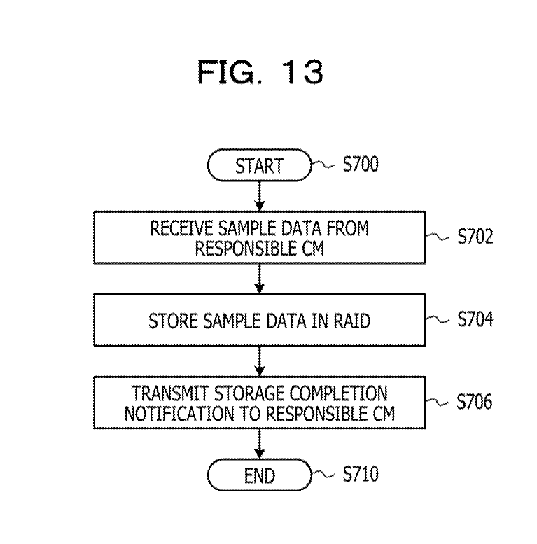

FIG. 13 is a flowchart illustrating processing of mode selection, which is executed by the processor 320 of the storage device 30. The processing flow is started in processing S700, and the data reception unit 322 receives sample data from the responsible CM in processing S702. In addition, in processing S704, the RAID control unit 325 stores the sample data in the RAID 32 (flash memory 390). In addition, in processing S706, the notification unit 326 transmits a storage completion notification to the responsible CM, and in processing S710, the processing flow ends.

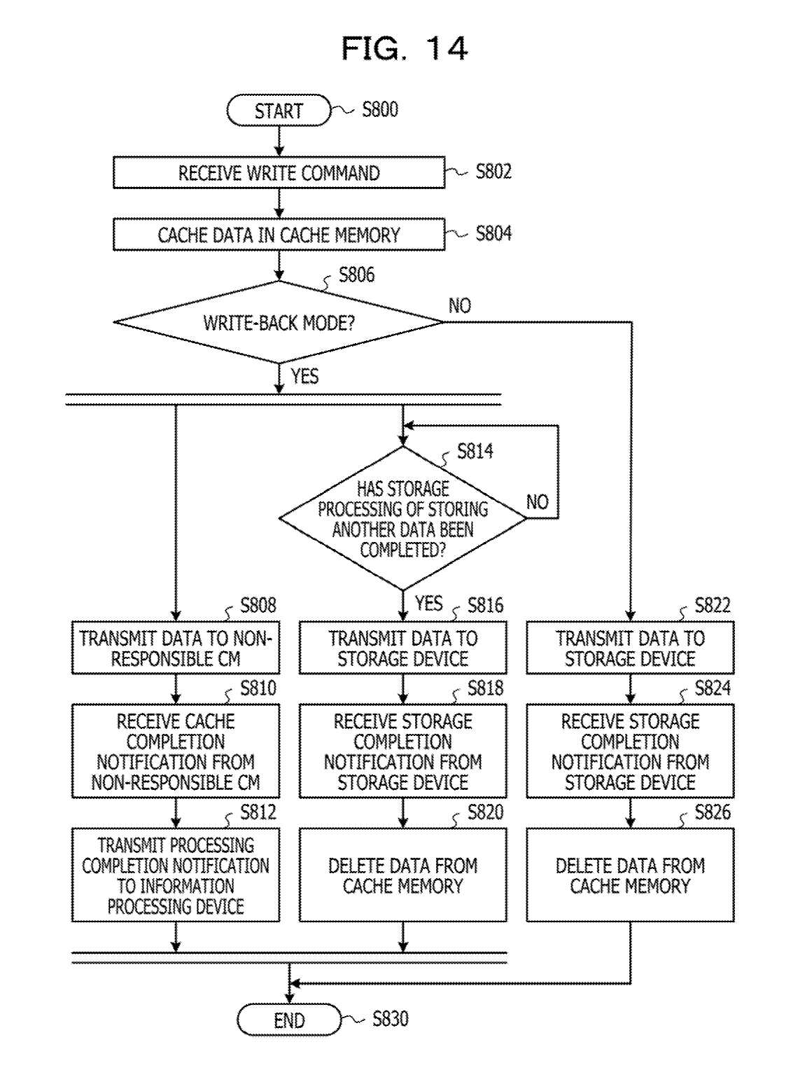

FIG. 14 is a flowchart illustrating processing when a write command has been input after the mode selection, which is executed by the processor 220 of the responsible CM. The processing flow is started in processing S800, and the command reception unit 223 receives a write command in processing S802. In addition, in processing S804, the cache memory control unit 224 causes the cache memory to cache target write data of the received write command. In processing S806, the mode control unit 222 determines whether the selected mode is the write-back mode. When the mode control unit 222 determines that the selected mode is the write-back mode, the processing flow proceeds to processing of S808 and S814, and processing corresponding to the write-back mode is executed. In addition, when the mode control unit 222 determines that the selected mode is not the write-back mode, the processing flow proceeds to processing S822, and processing corresponding to the write-through mode is executed.

When the processing of S808, S810, and S812 is processing in which the cache memory of the non-responsible CM is caused to store data. In the processing S808, the inter-CM communication control unit 225 transmits the data to the non-responsible CM. After that, in the processing S810, the inter-CM communication control unit 225 receives a cache completion notification from the non-responsible CM. In addition, in the processing S812, the notification unit 227 transmits a processing completion notification to the information processing device 10 that is a source of issuance of the write command after the storage completion notification has been received.

In addition, the processing of S814, S816, S818, and S820 in which data is stored in the storage device 30 is executed. In the processing S814, the storage control unit 226 determines whether storage processing of storing another data, for example, target data of a write command that had been previously received in the storage device 30 has been completed. When the storage control unit 226 determines that storage processing of storing another data has been completed, the processing flow proceeds to the processing S816, and when the storage control unit 226 determines that storage processing of storing another data is not completed, the processing S814 is repeatedly executed.

In the processing S816, the storage control unit 226 transmits data to the storage device 30. After that, in the processing S818, the storage control unit 226 receives a storage completion notification from the storage device 30. In addition, in the processing S820, the cache memory control unit 224 deletes the data in the cache memory, and the processing flow ends in processing S830.

In addition, in the processing S806, when the mode control unit 222 determines that the selected mode is not the write-back mode, that is, when the selected mode is the write-through mode, the storage control unit 226 transmits the data to the storage device 30 in the processing S822. After that, in processing S824, the storage control unit 226 receives a storage completion notification from the storage device 30. In addition, in processing S826, the cache memory control unit 224 deletes the data in the cache memory, and the processing flow ends the processing S830.

As described above, in the embodiment, a first time period taken to cause the cache memory of the non-responsible CM to cache sample data and a second time period taken to store sample data in the storage device 30 are measured. In addition, in accordance with comparison result between the first time period and the second time period, switching between the write-back mode and the write-through mode is performed. As a result, the response performance when the storage control device 20 has received a write command from the information processing device 10 may be improved. In addition, when the write-through mode has been selected, processing loads of the processors 220 of the CMs 21a and 21b may be suppressed.

Processing for maintaining data ordering when the mode is switched from the write-back mode to the write-through mode is described below.

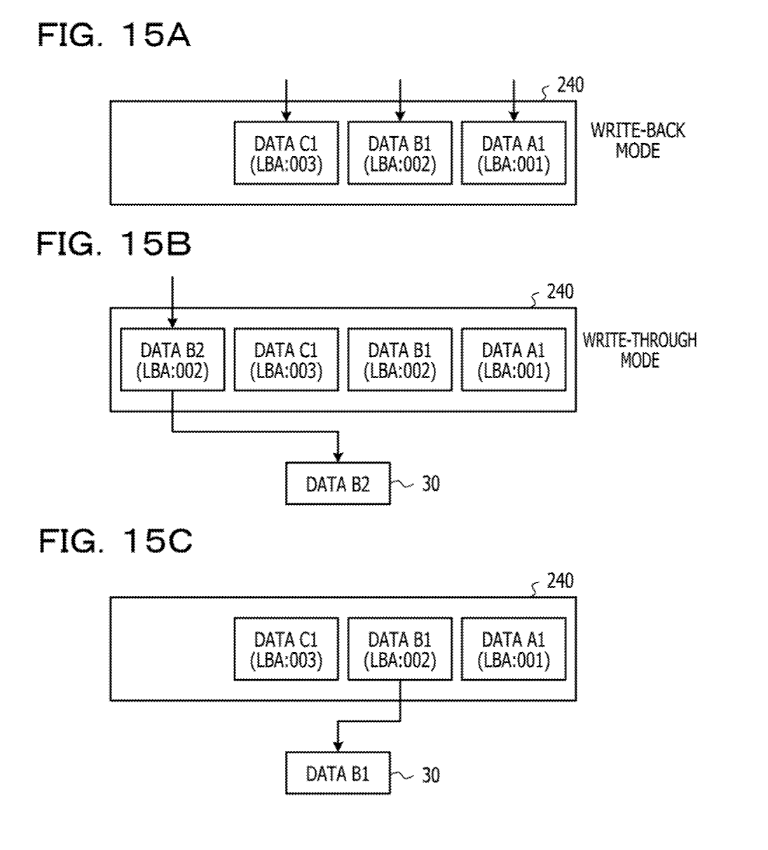

FIGS. 15A, 15B and 15C illustrate a case in which a problem occurs in data ordering when the mode is switched from the write-back mode to the rite-through mode. FIG. 15A illustrates a state in which, in the write-back mode, two or more write commands are input to the storage control device 20, and two or more target write data (data A1, data B1, and data C1) are cached in the cache memory (volatile memory 240) of the responsible CM. It is assumed that a logical block address (LBA) of the data A1 is 001, an LBA of the data B1 is 002, and an LBA of the data C1 is 003. These data are in a state of waiting for storage processing of storing data in the storage device 30.

After that, it is assumed that the mode is switched from the write-backmode to the write-through mode, and, in FIG. 15B, a write command of data B2 is input to the storage control device 20. The data B2 is revision data of the data B1, and an LBA of the data B2 is 002, which is identical to the LBA of the data B1. That is, the data B1 is data to be updated by the data B2. However, the data B2 is input to the storage control device 20 in the write-through mode, such that storage processing of storing the data B2 in the storage device 30 is executed synchronously the input to the storage control device 20. That, the data B2, which is an updated version, is stored in the storage device 30 prior to the data B1.

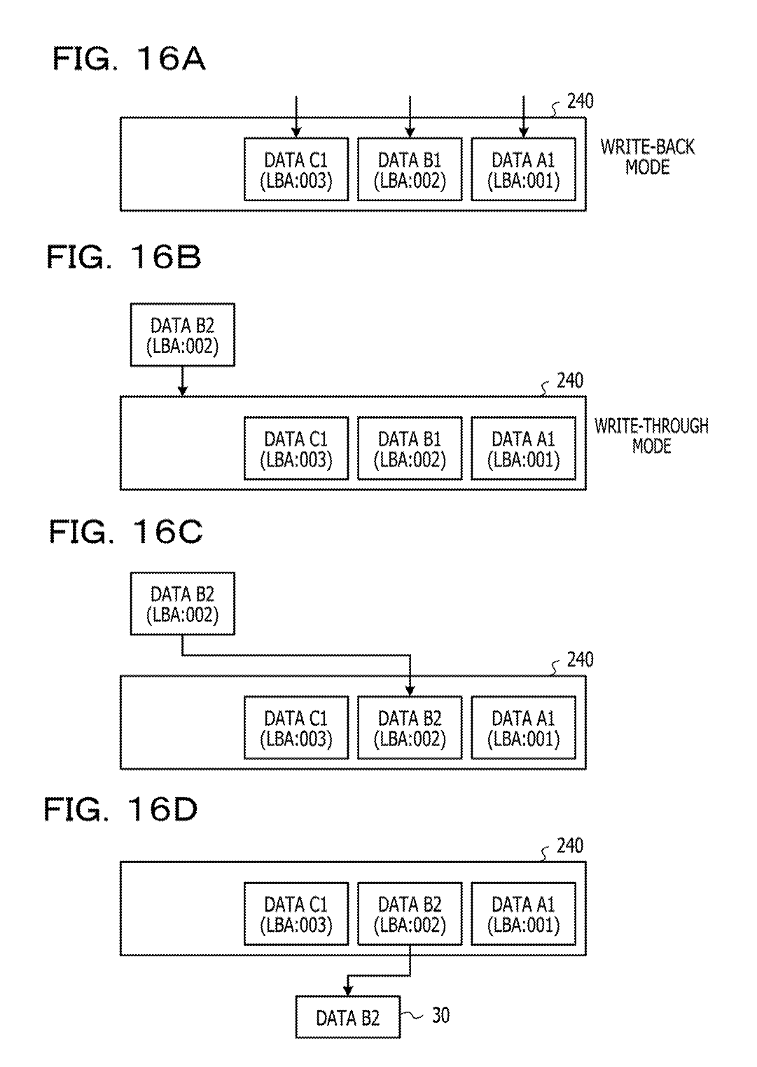

After that, in FIG. 15C, the data B1 that has been stored in the cache memory in the write-back mode is stored in the storage device 30. At this time, a problem occurs in which the data B2 (new data) that has been previously stored is overwritten by the data B1 (old data). In order to avoid such a problem, the processing illustrated in FIGS. 16A, 16B, 16C and 16D is executed.

FIGS. 16A, 16B, 16C and 16D illustrate a method in which the problem that occurs in the data ordering when the mode has been switched from the write-back mode to the write-through mode is solved. First, in FIG. 16A, similar to FIG. 15A, two or more write commands are input to the storage control device 20 in the write-back mode. In addition, two or more target write data (data A1, data B1, and data C1) are cached in the cache memory of the responsible CM.

After that, the mode is switched from the write-back mode to the write-through mode, and in FIG. 16B, a write command of data B2 is input to the storage control device 20. At this time, in FIG. 16C, the cache memory control unit 224 determines whether data having identical LBA as the LBA of the data B2 is cached in the cache memory. In addition, the LBA of the data B1 is identical to the LBA of the data B2, such that the data B1 is overwritten by the data B2 on the cache memory. By such processing, the data B1 is deleted on the cache memory, and alternatively, the data B2 is cached in the cache memory. After that, in FIG. 16D, the data B2 is stored in the storage device 30.

As described above, data input to the storage control device 20 and cached in the cache memory in the write-back mode is overwritten by updated data that has been input to the storage device 20 in the write-through mode. By such processing, the problem is solved in which new data that has been stored in the storage device 30 is overwritten by old data.

### Modification of the Mode Selection Method

In FIG. 1, each of the CMs 21a and 21b is described as a responsible CM for a single RAID 32, but may function as a responsible CM or two or more RAID 32.

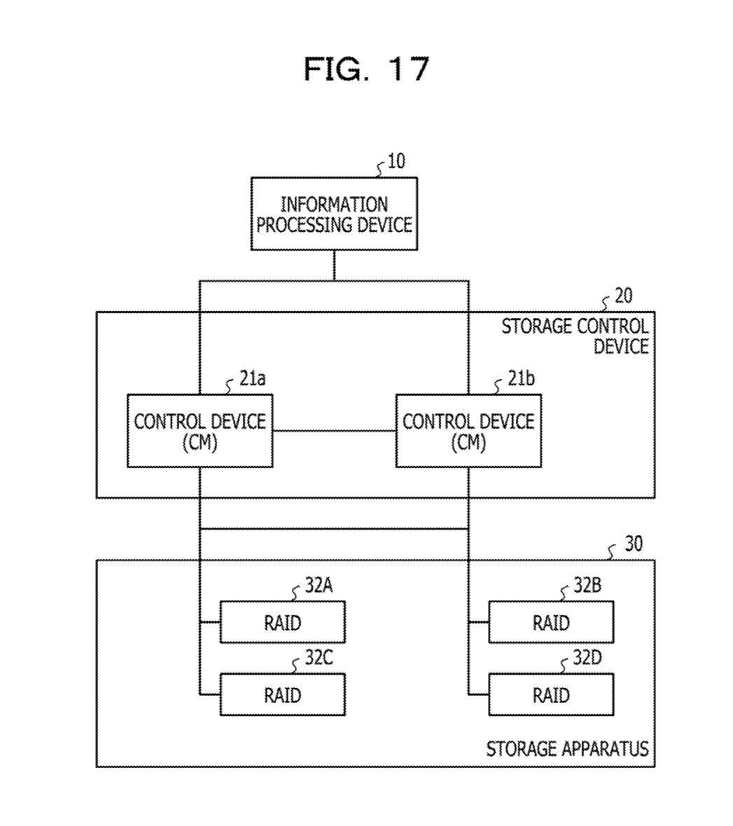

FIG. 17 is a diagram illustrating a storage system in which each CM 21 functions as a responsible CM for two or more RAID 32. In FIG. 17, a CM 21a is a responsible CM for the RAID 32A and 32C, and the CM 21b is a responsible CM for the RAID 32B and 32D.

In such a storage system, the CM 21a measures a time (second time period) until a storage completion notification is received after sample data has been transmitted to a storage device 30 for both RAID 32A and 32C. Similarly, a CM 21b measures a second time period for both RAID 326 and 32D.

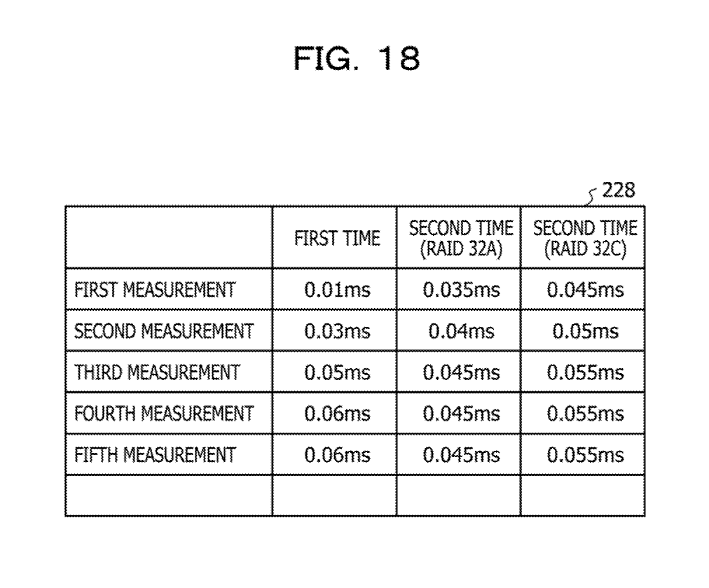

FIG. 18 is a diagram illustrating an example of registration contents of a management table 229 according to a modification. As illustrated in FIG. 10, a first time period and a second time period that have been measured by a measurement unit 228 are registered in the management table 229. In FIG. 18, the second time period that has been measured for each of the RAID 32A and 32C for which the CM 21a is responsible, are registered in the management table 229.

The mode selection unit 221 selects a mode in accordance with the management table 229. For example, a second time period for the RAID 32A is shorter than a first time period in the consecutive times of the third measurement and the fourth measurement. In accordance with such a fact, the mode selection unit 221 may select the write-through mode for the RAID 32A. The second time period for the RAID 32C is longer than the first time period in the third measurement. Thus, the first time period is not longer than the second time period in the consecutive times of the third measurement and the fourth measurement. Therefore, the mode selection unit 221 selects the write-through mode for the RAID 32A while maintaining the write-back mode for the RAID 32C.

As another mode selection method, the mode selection unit 221 may not select a mode for each RAID 32, and may select a mode that is common between two or more RAID 32. For example, when the second time period of the RAID 32A is shorter than the first time period in the fourth measurement, the write-through mode may be selected for both of the RAID 32A and 32C. In addition, as a further mode selection method, a mode may be selected, for example, in accordance with a trend of an average of the recent five measurement results for two or more RAID 32.

### Processing During Power Failure

Here, processing is described that is executed by the storage control device 20 when power supply to the storage control device 20 is recovered after having ceased.

First, a case is described in which the selected mode is the write-back mode. The data that has been received by the responsible CM 21 of the storage control device 20 in the state in which the write-back mode had been selected is cached in the cache memory of the responsible CM 21. In addition, the data is also cached in the cache memory of the non-responsible CM 21, and a processing completion notification is transmitted to the information processing device 10. After that, it is assumed that power supply to the storage control device 20 has ceased before the data is stored in the storage device 30. In this case, by alternative power supply through the battery 260, the data in the cache memory is written to the non-volatile memory 230. As a result, even when the power supply through the battery 260 has ceased, loss of the data may be avoided. After external power supply has been recovered, the data in the non volatile memory 240 is written to the cache memory, and storage processing of storing data in the storage device 30 from the cache memory is executed.

A case is described below in which the selected mode is the write-through mode. Data that has been received by the responsible CM 21 of the storage control device 20 in the state in which the write-through mode had been selected is cached in the cache memory of the responsible CM 21. It is assumed that, after the data is cached in the cache memory, power supply to the storage control device 20 has ceased before the data is stored in the storage device 30. In this case, processing is not executed in which the data in the cache memory is written to the non-volatile memory 240. Therefore, when alternative power supply through the battery 260 has ended before external power supply is recovered, the data is deleted from the CM 21. It is assumed that external power supply is recovered after the deletion of the data. In this case, when a processing completion notification for a write command that had been transmitted previously has not been received within a specific time period, the information processing device 10 transmits a write command again. In addition, when the write command that had been transmitted again has been received by the responsible CM 21 of the storage control device 20 in the state in which the write-through mode has been selected, the data is stored in the storage device 30 in the write-through mode. After that, a processing completion notification is transmitted to the information processing device 10. When the write command that had been transmitted again has been received by the responsible CM 21 of the storage control device 20 in the state in which the write-back mode has been selected, the data is stored in the non-responsible CM in the write-back mode, and a processing completion notification is transmitted to the information processing device 10. After that, the data is stored in the storage device 30.

Finally, a case is described in which the mode has been switched from the write-back mode to the write-through mode. A state is assumed in which data that has been input to the responsible CM 21 in the write-back mode and data that has been input to the responsible CM 21 in the write-through mode are mixed in the cache memory. It is assumed that a processing completion notification has already been transmitted to the information processing device 10 for data that has been received in the write-back mode. After that, it is assumed that power supply to the storage control device 20 has ceased before the data is stored in the storage device 30. In this case, due to alternative power supply through the battery 260, from among data in the cache memory, data that has been received in the write-back mode is written to the non-volatile memory 230. In addition, the data that has been received in the write-through mode is not written to the non-volatile memory 230. After external power supply has been recovered, the data in the non-volatile memory 230 is written to the cache memory, and storage processing of storing the data in the storage device 30 from the cache memory is executed. For the data that has not been written to the non-volatile memory 230, the storage processing of storing the data in the storage device 30 is executed when a write command has been transmitted from the information processing device 10 again.

As described above, even when the mode has been switched from the write-back mode to the write-through mode, and external power supply has ceased, data may be stored in the storage device 30 after external power supply has been recovered. For the data that has been received in the write-through mode, when a write command has been transmitted from the information processing device 10 again, the storage processing of storing the data in the storage device 30 is executed.

Here, the above-described processing is executed, such that the CM 21 includes a function to identify data that has been received in the write-back mode and data that has been received in the write-through mode. For example, when the CM 21 causes the cache memory to cache data, the CM 21 generates and caches a flag indicating that the data has been received in the write-back mode or the write-through mode. In addition, whether data is written to the non-volatile memory 230 by power supply through the battery 260 is determined in accordance with the flag.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control device configured to store first data transmitted from an information processing device to a storage device, the storage control device comprising:
a first control device including a first memory and a first processor coupled to the first memory; and
a second control device including second memory and a second processor coupled to the second memory, wherein
the first processor is configured to:
at a first time point, transmit second data to the second control device,
at a second time point, receive, from the second control device, a first completion notification indicating that the second data is held in the second control device,
at a third time point, transmit the second data to the storage device,
at a fourth time point, receive, from the storage device, a second completion notification indicating that the second data is stored in the storage device,
measure a first time period from the first time point to the second time point, and a second time period from the third time point to the fourth time point,
select one of a first mode and a second mode based on a comparison result of the first time period and the second time period,
when the first mode is selected,
transmit the first data transmitted from the information processing device to the second control device and the storage device,
receive, from the second control device, the first completion notification indicating that the first data is held in the second control device,
transmit a processing completion notification to the information processing device when the first completion notification is received, and
when the second mode is select,
transmit, to the storage device, the first data transmitted from the information processing device,
receive, from the storage device, the second completion notification indicating that the first data is stored in the storage device, and
transmit the processing completion notification to the information processing device when the second completion notification is received.

2. The storage control device according to claim 1, wherein
the first processor is configured not to transmit the first data to the second control device in the second mode.

3. The storage control device according to claim 1, wherein
the first control device includes a first cache memory,
the second control device includes a second cache memory,
in the first mode and in the second mode, when the first data is received by the first control device, the first cache memory holds the first data, and
in the first mode, when the first data is transmitted to the second control device, the second cache memory holds the first data.

4. The storage control device according to claim 3, wherein
when an error occurs in the first control device, and the first data is not transmitted from the first control device to the storage device, the second processor transmits the first data held in the second cache memory to the storage device.

5. The storage control device according to claim 1, wherein
the storage device includes at least one of a solid state drive and a hard disk drive.

6. The storage control device according to claim 1, wherein
the first processor is configured to
select the first mode when the first time period is shorter than the second time period, and
select the second mode when the second time period is shorter than the first time period.

7. The storage control device according to claim 1, wherein
the second data is sample data, and
the first processor is configured to:
measure the first time period and the second time period multiple times by transmitting the sample data to the second control device and the storage device multiple times, and
select the first mode when the first time period is shorter than the second time period in a consecutive measurement of the multiple times, and select the second mode when the second time period is shorter than the first time period in a consecutive measurement of the multiple times.

8. The storage control device according to claim 3, wherein
the first processor is configured to receive, in the first mode from the storage device, the second completion notification indicating that the second data is stored in the storage device, and
the first cache memory holds third data when the third data is received by the first processor before the second completion notification is received by the first processor after the processing completion notification is transmitted to the information processing device, and after the second completion notification is received by the first processor, the third data is transmitted to the storage device.

9. The storage control device according to claim 1, wherein
the storage device includes redundant arrays of inexpensive disks (RAID), and
the second data is stored in the RAID in a redundant manner.

10. A method of storing first data transmitted from an information processing device to a storage device, the method being executed by a first control device coupled to a second control device, the method comprising:
at a first time point, transmitting second data to the second control device;
at a second tine point, receiving, from the second control device, a first completion notification indicating that the second data is held in the second control device;
at a third time point, transmitting the second data to the storage device;
at a fourth time point, receiving, from the storage device, a second completion notification indicating that the second data is stored in the storage device;
measuring a first time period from the first time point to the second time point, and a second time period from the third time point to the fourth time point;
selecting one of a first mode and a second mode based on a comparison result of the first time period and the second time period;
when the first mode is selected,
transmitting the first data transmitted from the information processing device to the second control device and the storage device;
receiving, from the second control device, the first completion notification indicating that the first data is held in the second control device;
transmitting a processing completion notification to the information processing device, when the first completion notification is received; and
when the second mode is select,
transmitting, to the storage device, the first data transmitted from the information processing device;
receiving, from the storage device, the second completion notification indicating that the first data is stored in the storage device; and
transmitting the processing completion notification to the information processing device when the second completion notification is received.

11. The method according to claim 10, wherein
the first data is not transmitted to the second control device in the second mode.

12. The method according to claim 10, wherein
the first control device includes a first cache memory,
the second control device includes a second cache memory,
in the first mode and in the second mode, when the first data is received by the first control device, the first cache memory holds the first data, and
in the first mode, when the first data is transmitted to the second control device, the second cache memory holds the first data.

13. The method according to claim 12, wherein
when an error occurs in the first control device, and the first data is not transmitted from the first control device to the storage device, the second processor transmits the first data held in the second cache memory to the storage device.

14. The method according to claim 10, wherein
the storage device includes at least one of a solid state drive and a hard disk drive.

15. The method according to claim 10, wherein
the first mode is selected when the first time period is shorter than the second time period, and
the second mode is selected when the second time period is shorter than the first time period.

16. The method according to claim 10, wherein
the second data is sample data, and
the first time period and the second time period are measured multiple times by transmitting the sample data to the second control device and the storage device multiple times,
the first mode is select when the first time period is shorter than the second time period in a consecutive measurement of the multiple times, and
the second mode is selected when the second time period is shorter than the first time period in a consecutive measurement of the multiple times.

17, The method according to claim 12, further comprising:
receiving, in the first mode from the storage device, the second completion notification indicating that the second data is stored in the storage device, wherein
the first cache memory holds third data when the third data is received by the first control device before the second completion notification is received by the first control device after the processing completion notification is transmitted to the information processing device, and after the second completion notification is received by the first control device, the third data is transmitted to the storage device.

18. The method according to claim 10, wherein
the storage device includes redundant arrays of inexpensive disks (RAID), and
the second data is stored in the RAID in a redundant manner.

19. A storage system comprising:
a first control device including a first memory and a first processor coupled to the first memory;
a second control device including a second memory and a second processor coupled to the second memory; and
storage device, wherein
the first processor is configured to
at a first time point, transmit second data to the second control device,
at a second time point, receive, from the second control device, a first completion notification indicating that the second data is held in the second control device,
at a third time point, transmit the second data to the storage device,
at a fourth time point, receive, from the storage device, a second completion notification indicating that the second data is stored in the storage device,
measure a first time period from the first time point to the second time point, and a second time period from the third time point to the fourth time point,
select one of a first mode and a second mode based on a comparison result of the first time period and the second time period,
when the first mode is selected,
transmit first data transmitted from an information processing device to the second control device and the storage device,
receive, from the second control device, the first completion notification indicating that the first data is held in the second control device,
transmit a processing completion notification to the information processing device when the first completion notification is received, and
when the second mode is select,
transmit, to the storage device, the first data transmitted from the information processing device,
receive, from the storage device, the second completion notification indicating that the first data is stored in the storage device, and
transmit the processing completion notification to the information processing device when the second completion notification is received.

20. The storage system according to claim 19, wherein
the first processor is configured not to transmit the first data to the second control device in the second mode.
